(19) United States
(12) Patent Application Publication
(10) Pub. No.: US 2019/0057404 A1
(43) Pub. Date: Feb. 21, 2019

(54) JOBS FORECASTING

(71) Applicant: LinkedIn Corporation, Sunnyvale, CA (US)

(72) Inventors: Zhifeng Deng, Santa Clara, CA (US); Hong Li, Fremont, CA (US); Ryan Bixby Smith, Sunnyvale, CA (US); Kun Liu, Sunnyvale, CA (US); Aman Grover, Sunnyvale, CA (US)

(21) Appl. No.: 15/677,773

(22) Filed: Aug. 15, 2017

(51) Int. Cl. G06Q 30/02; G06Q 10/10

(52) U.S. Cl. CPC G06Q 30/0202; G06Q 10/1053

(57) ABSTRACT

Disclosed in some examples are systems, methods, and machine readable mediums which provide for a forecasting service that, given a query that specifies job posting features produces one or more forecasted metrics for that job posting information over a particular period of time for a pay-per-click job posting model. By providing forecasting metrics, it allows job posters an ability to plan with a degree of certainty how much a particular job post is going to cost given a bid. Moreover, the metrics may visually show an expected value to the job poster for posting the job on the job posting service.

### TECHNICAL FIELD

Embodiments pertain to online job posting marketplaces. Some embodiments relate to social networking services. Some embodiments pertain to social networking services that include online job posting marketplaces.

### BACKGROUND

Employers or recruiters may create and submit online job postings to network-based computer services called job posting services. These postings contain information on a job opening of an employer (hereinafter job posting features). Job seekers may search the posted job postings for jobs that they are interested in. In some examples, the job seekers may apply online for the job and the employer may receive information on (e.g., resumes and/or profile information) the job seekers that applied. The employer may then decide which candidates to bring in for interviews, further evaluation, or to hire.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a schematic of a forecast system of a job posting service according to some examples of the present disclosure.

FIG. 2 shows a flowchart of a method of forecasting a job posting metric according to some examples of the present disclosure.

FIG. 3 shows a flowchart of a method of creating a forecast model from past observations according to some examples of the present disclosure.

FIG. 4 shows an example machine learning module according to some examples of the present disclosure.

FIG. 5 is a block diagram showing the functional components of a job posting service according to some examples of the present disclosure.

FIG. 6 illustrates a block diagram of an example machine upon which any one or more of the techniques (e.g., methodologies) discussed herein may perform according to some examples of the present disclosure.

### DETAILED DESCRIPTION

To post a job on the job posting service the job poster enters job posting features such as the job title, location, the company name, and member targeting information that list the desired and/or required characteristics (e.g., job title, geographical location, skills) of the member that the job poster is looking for. In addition, when posting to traditional job posting services, the job poster pays a flat fee to activate (e.g., show) the job posting for a particular amount of time on the job posting service. During this time period the job posting is visible to job seekers and other users of the job posting service as a search result, an advertised job posting (e.g., highlighted or otherwise shown to a user like an advertisement), a recommendation to users, and the like. The fee charged by the job posting service may be high for the job posting which poses a large barrier for entry and depending on the circumstances, may represent a poor value for some companies. For example, job posters may be unsure that the fixed fee will be worth the quality and quantity of candidates obtained from the posting.

Instead of a fixed fee for a particular job application, in some examples, a job posting service may utilize a pay-per-click model. That is, job posters pay a fee for each time a member selects the job posting for further inquiry when that posting is shown to the member (called an impression). The fee that is paid is determined by the job poster and may be termed a “bid.” Selecting a job posting may comprise clicking on or otherwise entering an input signifying an intention to view the job.

As selecting a job posting requires showing the job posting (or a summary of it) to a user, when a job posting placement opportunity arises, the job posting service may select or order job postings to fill these opportunities based upon a job score that may depend on the job poster's bid. Thus, the higher the bid of the job poster, the more likely the job posting will receive an impression. As a result, the system may be thought of as an auction system. Example job posting placement opportunities comprise one or more spots on a webpage, email, or other communication for recommending or otherwise advertising a job posting, a job search results page, and the like.

In some examples, because utilizing only the bid price in scoring job postings (and thus determining job posting placements) may cause the presentation of jobs that do not meet the criteria of job seekers (and a subsequent decline in the usefulness of the job posting service), other factors may be utilized in calculating a job score. For example, the job posting service may take into account jobs that are relevant to the particular user to which it is shown. As another example, the job posting service may take into account the quality of the user to which the job posting is shown. Thus, in some examples, the job posting service may balance three different utilities—the job seeker's utility in finding good jobs, the job poster's utility in finding quality applicants, and the job posting service's utility in collecting payment.

As bid price is one component in selecting which job postings to utilize in a job posting placement, job posters will need to carefully consider how much they wish to bid. Job posters typically have budgets they are allocated to spend on advertising a job posting. Bid too low and they will get few placements, bid too high and they may have too many placements and get overwhelmed with applicants. Because the number of impressions is unknown, it is difficult for job posters to adequately determine how much to pay for a particular click given a budget for a particular job posting.

Disclosed in some examples are systems, methods, and machine readable media which provide for a forecasting service that, given a query that specifies job posting features produces one or more forecasted metrics for that job post for a particular period of time. Job posting features include information about a job and comprise one or more of: company, job title, geographical location, and other features of the job posting. Metrics are a measure of a number of interactions that members of the job posting service have with the job posting over the particular period of time. Interactions include an impression, a view, an application, and the like. Metrics include a number of impressions, a number of views, a number of applications, and/or a number of qualified applications, and the like. As the disclosed techniques provide for forecasting metrics, they allow job posters an ability to plan with a degree of certainty how much a particular job post is going to cost given a bid. Moreover, the metrics may visually show an expected value to the job poster for posting the job on the job posting service.

In some examples the metrics may be made available to the job poster on a user interface (e.g., a Graphical User Interface (GUI)) and/or through an application programming interface (API). For example, through a REpresentational State Transfer (REST) interface. In some examples, the time duration may be fixed, or may be specified by the user through the GUI or API. The prediction may take into account the information about the job posting such as the company, job title, geographical location, and the like to produce the prediction. In some examples, the prediction may be made at job posting creation time. In other examples, the prediction may be updated as actual data is determined.

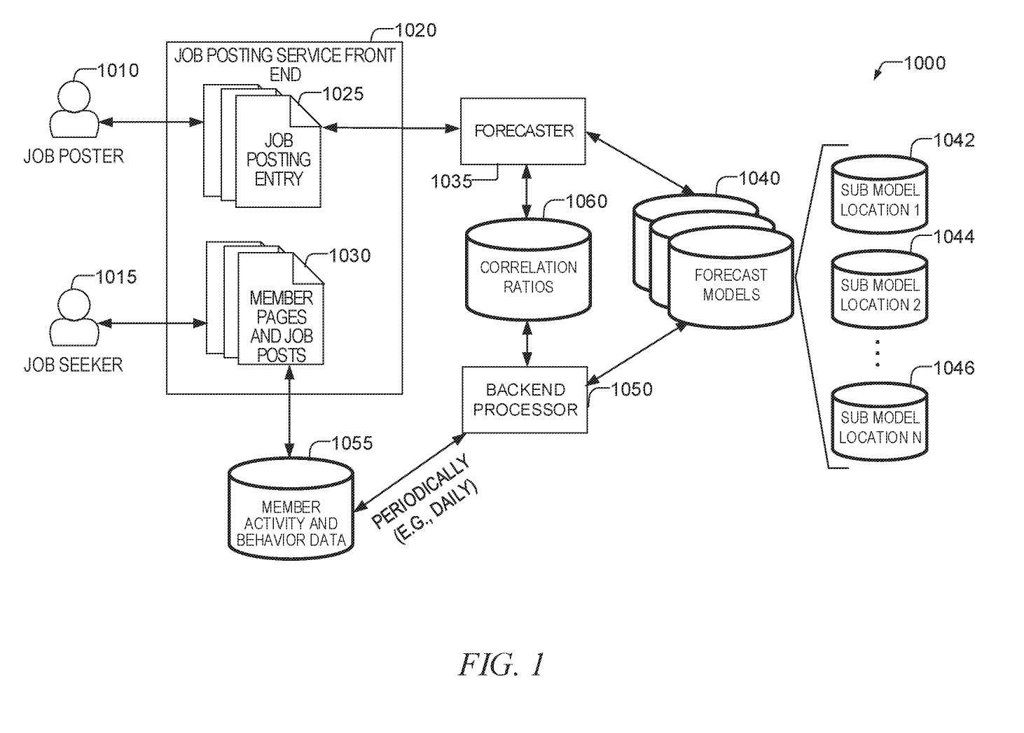

Turning now to FIG. 1 a schematic of a forecast system 1000 of a job posting service is shown according to some examples of the present disclosure. A job seeker 1015 may access a job posting service through job posting service front end 1020 to access member pages, job search pages, content pages, job postings, and other content 1030. When the member interacts with job postings, the interactions may be logged in member activity and behavior database 1055. For example, impressions, views, applications, and other interactions may be logged (including information on the time, date, and the like) and a quantity of each type of interaction over a predetermined time period may be calculated. For example, a user may view a certain job posting 3 times in a week.

In some examples, the data is aggregated across member segments. A member segment may be a group of members that share one or more common traits. For example, a member segment may be all members of the job posting service that are software engineers in California. Thus, the system may calculate, for each interaction type, an aggregate number of interactions with each job posting for each member that matches a segment's traits. In some examples, members may belong to more than one segment. For example, a member may match the segment traits for multiple segments. In these examples, the member's interactions may count towards the aggregate interactions for multiple segments.

The backend processor 1050 may utilize the interaction data to generate a plurality of forecast models 1040. In some examples, the interaction data used by the backend processor 1050 may be the aggregate data. Forecast models 1040 may be a plurality of time series models. In some examples, a different forecast model is built for each of the possible forecasted metrics (impression, views, applications, unique # of applicants, and the like). In other examples, a single model may be built (e.g., an impression model) and a conversion ratio may be determined (e.g., learned through a machine learning model such as logistic regression) that quantifies the expected number of other interactions given an impression. This may be learned through logistic regression of past histories of the other interactions given an impression of a particular job application.

Each model for each metric may also be broken down by geographical region. Thus, a model may have a number of submodels 1042, 1044, and 1046 that each correspond to a unique geographical region. In some examples the forecast models 1040 may be time series models. For example, the interaction data may be in the form of a past time series, and the prediction may be of a future time series. The forecast model may be a periodic mean value forecast which uses past means to forecast future metric values. Thus, the forecast for next Tuesday's metric might be a mean of several previous Tuesdays. In other examples, the forecasts may be a seasonal auto-regressive integrated moving average (seasonal ARIMA). Seasonal ARIMA assumes that the future is a linear combination of the recent past metrics with some correction for seasonal affects. For example, for an impressions score, ARIMA calculates a future prediction based upon a weighted summation of the impressions at various times in the past. The model then tries to learn the coefficients (e.g., the weights) to apply to points in the past to arrive at the forecast. The model then comprises the co-efficients as well as the algorithm that produces the prediction.

To further refine the forecast, the backend processor 1050 may learn a number of correlation ratios 1060. Correlation ratios 1060 adjust between the base forecast produced by forecast models 1040 (that is, the forecast for all job postings that target all users in a particular geographic area) to produce a forecast that is specific for particular member targets (e.g., which members the job poster is targeting), the company that posted the job, and the like. There may be many correlation ratios that are generated for each combination of member target characteristic and job posting feature. These correlation ratios may be calculated as a ratio over a predetermined period of time of a mean value of the metric for all users in a particular geographic area for all job postings and a mean value of the metric for the particular combination. Thus for example, if the mean impression for all job postings for a particular area in the past 30 days is X and the mean impressions for software engineers at high profile software companies that are targeting software engineers with 10 years of experience is Y, then the correlation ratio may be X divided by Y. In other examples the correlation ratios may be learned by machine learning algorithms such as logistic regression.

As noted one feature may be member targeting features, which are member characteristics that are being targeted by the job poster with the job posting. For example, industry, title, location, skills, and the like. Additionally, as noted, job posting features may include information such as company features. The inclusion of company features in the forecast is an acknowledgement that some companies have more prestige than other companies and thus would naturally attract more applicants. Despite this, data for many companies may be sparse. Thus, in some examples, the company name may be abstracted to a size or prestige rating to reflect how large and/or desirable the company is to work for (e.g., as determined by an administrator of the job posting service).

Job poster 1010 may interact with the job posting service front end 1020 by accessing job posting entry pages, management pages, and the like 1025. Job posting entry pages 1025 may display a forecast of a metric for a target job posting (either a proposed job posting or an existing job posting). To produce this forecast the job posting service front end 1020 may pass the features of the target job posting to the forecaster 1035 which may utilize the forecast models 1040 corresponding to the job posting's geographical area and the correlation ratios 1060 for the member targeting features and company features to produce a forecast for one or more metrics.

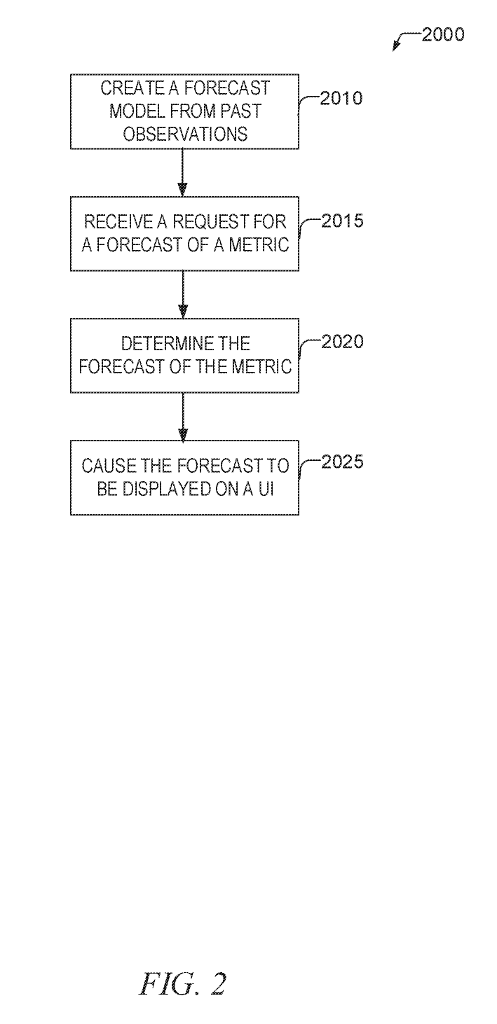

Turning now to FIG. 2 a flowchart of a method 2000 of forecasting a job posting metric is shown according to some examples of the present disclosure. At operation 2010 the job posting service may create a forecast model from past observations of the metric. This model may be a machine learned model, such as a seasonal ARIMA model. As noted, a separate model may be made for every metric and models may differ based upon geographic location. At operation 2015 the job posting system may receive a request for a forecast of a metric. The request may include the desired metric, job posting features, member targeting features, a proposed bid, and the like. At operation 2020 the job posting service may determine the forecast of the metric. For example, the job posting service locates the appropriate time series and utilizes it to forecast the requested metric. In some examples, the job posting service may apply an appropriate correlation ratio selected based upon the desired metric, job posting features, member targeting features, proposed bid, and the like. At operation 2025 the job posting service may cause the forecast to be displayed on a user interface, such as a Graphical User Interface (GUI).

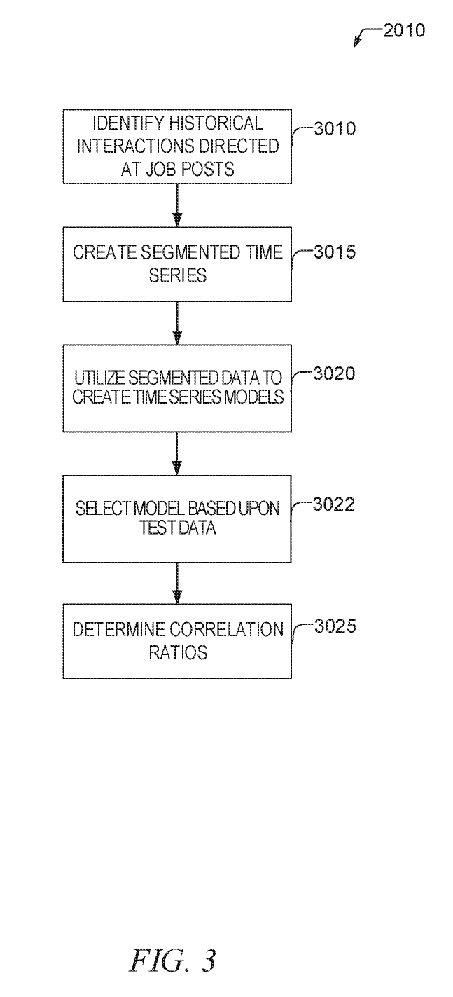

Turning now to FIG. 3, a flowchart of a method 2010 of creating a forecast model from past observations is shown according to some examples of the present disclosure. At operation 3010 the job posting service may identify one or more historical interactions of the members of the job posting service that are directed towards job postings. For example, impressions, views, applications, and other types of behaviors. As previously described the job posting service may collect this information and may store it in a database. Identifying the historical interactions may include storing the interactions in the database, and then later retrieving those interactions from the database. Metadata such as the time and date the interaction took place, and other contextual information may also be collected and stored. The time and date information in particular may be utilized to create a time series from the data.

At operation 3015 the system may create a segmented time series. First, the historical interaction data may be grouped together based upon members that match a particular segment's member characteristics. For example, a segment might be deep sea fisherman from Florida, and the historical interactions may be grouped such that the historical interaction information for all members who are deep sea fisherman from Florida are grouped together. This grouped data may then be utilized to create a time series. That is, each interaction for the group for a first period of time (e.g., a day) may be summed and stored (e.g., in an array) and the process may be repeated for a predetermined time range (e.g., a month's worth of interaction data). Thus the interaction information may be an array of impression counts for each day for a particular month for all members that match the segment's criteria.

At operation 3020 a time series model may be created based upon the time series data. As noted, the time series model may be a periodic mean value forecast, an ARIMA model, a seasonal ARIMA model, and the like. In some examples, multiple time series models may be generated at operation 3020. In these cases, some of the historical data may not be utilized to create the model at operation 3020, but instead may be utilized as test data to test the accuracy of the generated models. At operation 3022 if multiple models were created, the test data may be utilized to select the most accurate model. For example, the model that had the lowest average error for a prediction over a predetermined future time frame, such as evaluated after the predetermined future time frame has occurred.

At operation 3025 correlation ratios may be determined based upon the historical time series data. For example, for each combination of job posting features, member targeting features, and the like, a correlation ratio may be calculated that describes an expected proportion of the total metric that is attributable to members with the member targeting features interacting with a job posting with the job posting features. As previously noted, the correlation ratios may be based upon evaluation of the mean value of the metric in the historical time series data across a period of time as compared with a mean value of the metric when only considering job postings matching the job posting features, member targeting features, and the like. In other examples, the correlation ratios may be a machine learned value (e.g., through logistic regression).

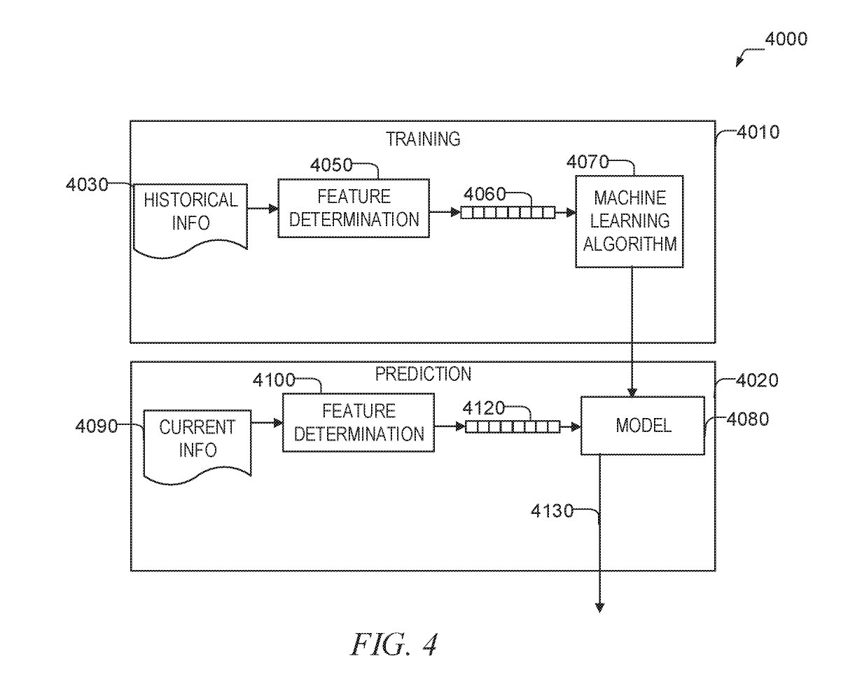

As previously described, the system may calculate one or more conversion ratios, correlation ratios, and the like based upon one or more machine learning algorithms. FIG. 4 shows an example machine learning module 4000 according to some examples of the present disclosure. Machine learning module 4000 utilizes a training module 4010 and a prediction module 4020. Training module 4010 inputs historical information 4030 into feature determination module 4050. The historical information 4030 may be labeled. Example historical information may include member interactions with job postings, time series data, corresponding member features, job posting features, metric data, and the like. Labels may include an indication or quantity of an interaction that occurred between the member with particular member features and a job posting with particular job posting features.

Feature determination module 4050 determines one or more features 4060 from this historical information 4030. Stated generally, features 4060 are a set of the information input and is information determined to be predictive of a particular outcome. Example features are given above. In some examples, the features 4060 may be all the historical activity data, but in other examples, the features 4060 may be a subset of the historical activity data. The machine learning algorithm 4070 produces a model 4080 based upon the features 4060 and the label.

In the prediction module 4020, current information 4090 may be input to the feature determination module 4100. Feature determination module 4100 may determine the same set of features or a different set of features from the current information 4090 as feature determination module 4050 determined from historical information 4030. In some examples, feature determination module 4100 and 4050 are the same module. Feature determination module 4100 produces feature vector 4120, which is input into the model 4080 to generate a likelihood of response score 4130. The training module 4010 may operate in an offline manner to train the model 4080. The prediction module 4020, however, may be designed to operate in an online manner. It should be noted that the model 4080 may be periodically updated via additional training and/or user feedback.

The machine learning algorithm 4070 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C4.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training module 4010. In an example embodiment, a regression model is used and the model 4080 is a vector of coefficients corresponding to a learned importance for each of the features in the vector of features 4060, 4120. To calculate a score, a dot product of the feature vector 4120 and the vector of coefficients of the model 4080 is taken.

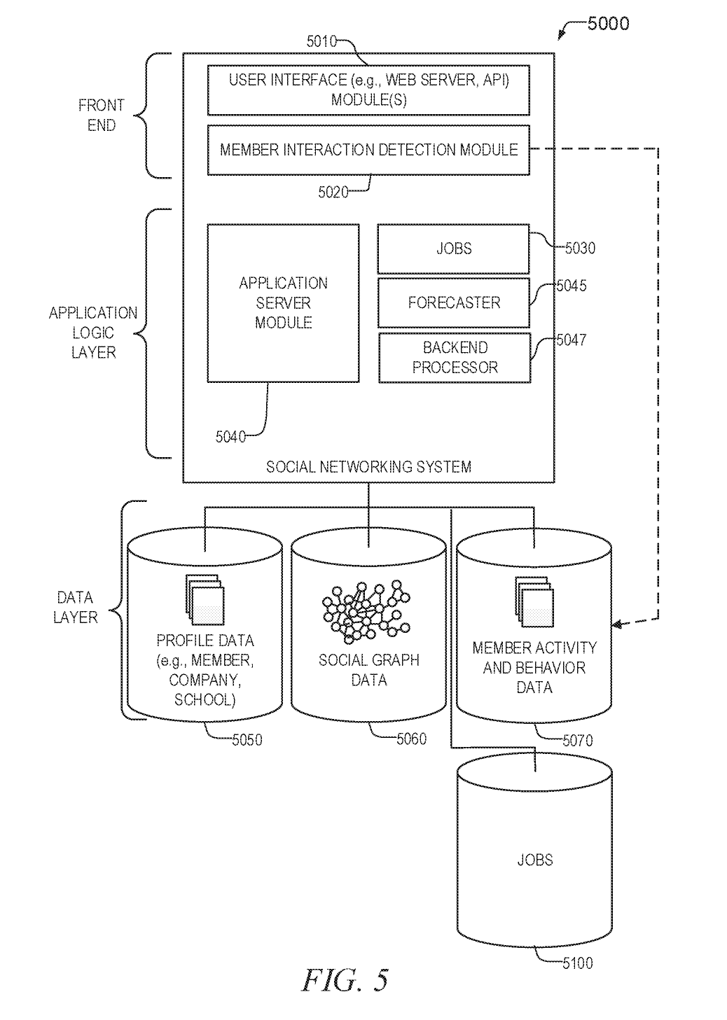

FIG. 5 is a block diagram showing the functional components of a job posting service 5000. As shown in FIG. 5, a front end module (which may implement a job posting service front end 1020 of FIG. 1) may comprise a user interface module (e.g., a web server) 5010, which receives requests from various client-computing devices, and communicates appropriate responses to the requesting client devices. For example, the user interface module(s) 5010 may receive requests in the form of Hypertext Transport Protocol (HTTP) requests, or other network-based, application programming interface (API) requests (e.g., from a dedicated application running on a client device). In addition, a user interaction and detection module 5020 may be provided to detect various interactions that users have with different applications, services and content presented. As shown in FIG. 5, upon detecting a particular interaction, the user interaction and detection module 5020 logs the interaction, including the type of interaction and any meta-data relating to the interaction, in the user activity and behavior database 5070. User activity and behavior database 5070 may be an example of the user activity and behavior database 1055 of FIG. 1.

An application logic layer may include one or more various application server modules 5040, which, in conjunction with the user interface module(s) 5010, generate various graphical user interfaces (e.g., web pages) with data retrieved from various data sources in the data layer. With some embodiments, application server module 5040 is used to implement the functionality associated with various applications and/or services provided by the job posting service as discussed above.

Application logic layer may also include jobs module 5030 which, in conjunction with application server module 5040 provides the ability to post jobs (including inputting a cost-per-click or other interaction and setting a total budget), view jobs, search jobs, apply for jobs, and the like via one or more user interfaces provided by jobs module 5030 to users of the job posting service 5000. Backend processor 5047 may be an example of backend processor 1050 of FIG. 1 and may produce one or more time series forecast models (e.g., models such as forecast models 1040 of FIG. 1), one or more correlation ratios (e.g., correlation ratios such as correlation ratios 1060 of FIG. 1), one or more conversion ratios, and the like. The backend processor 5047 may include or implement the machine learning modules of FIG. 4. Forecaster 5045 may be an example of forecaster 1035 of FIG. 1 and may utilize the models, conversion ratios, and/or correlation ratios produced by the backend processor 5047 along with job posting features, member targeting features to produce a forecasted metric for a job posting. This forecast may be returned to the user interface module 5010 for presentation to a job poster.

Jobs data structures 5100 may be part of a data layer which may include several other databases, such as a database 5050 for storing profile data, including both member profile data as well as profile data for various organizations (e.g., companies, schools, etc.). Consistent with some embodiments, when a person initially registers to become a member of the job posting service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 5050. Similarly, when a representative of an organization (e.g., a job poster) initially registers the organization with the job posting service, the representative may be prompted to provide certain information about the organization. This information may be stored, for example, in the database 5050, or another database (not shown). With some embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

In some examples, as noted the job posting service may be integrated with a social networking service. In these examples, information describing the various associations and relationships, such as connections that the members establish with other members, or with other entities and objects, is stored and maintained within a social graph in the social graph database 5060. Also, as members interact with the various applications, services, and content made available via the social networking service, the members' interactions and behavior (e.g., content viewed, links or buttons selected, messages responded to, etc.) may be tracked and information concerning the member's activities and behavior may be logged or stored, for example, as indicated in FIG. 3 by the member activity and behavior database 5070.

With some embodiments, the job posting service 5000 provides an application programming interface (API) module with the user interface module 5010 via which applications and services can access various data and services provided or maintained by the job posting service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

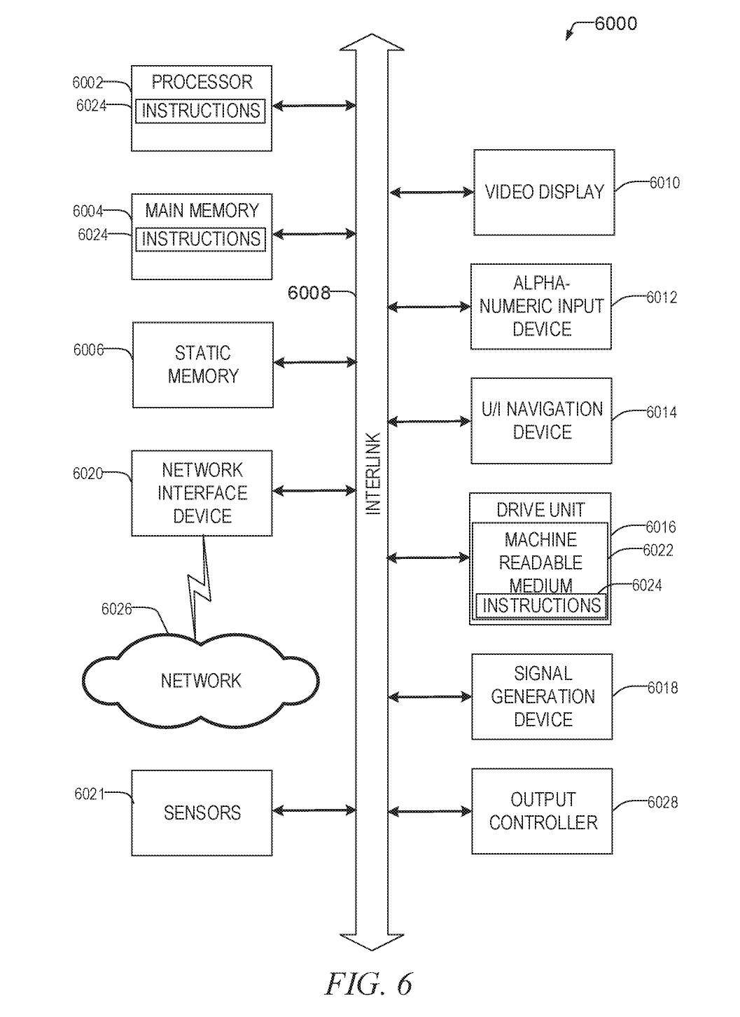

FIG. 6 illustrates a block diagram of an example machine 6000 which may implement more of the techniques (e.g., methodologies) discussed herein. In alternative embodiments, the machine 6000 may operate as a standalone device or may be connected (e.g., networked) to other machines. In a networked deployment, the machine 6000 may operate in the capacity of a server machine, a client machine, or both in server-client network environments. In an example, the machine 6000 may act as a peer machine in peer-to-peer (P2P) (or other distributed) network environment. The machine 6000 may be a server computer, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Machine 6000 may be configured to implement the job posting service 5000, forecast system 1000, or may be communicatively linked with other similar machines to implement the job posting service. Machine 6000 may implement the systems of FIG. 1 and FIG. 5, the machine learning module 4000, and perform the methods of FIGS. 2 and 3. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 6000 may include a hardware processor 6002 (e.g., a central processing unit (CPU), a graphics processing unit (GPU), a hardware processor core, or any combination thereof), a main memory 6004 and a static memory 6006, some or all of which may communicate with each other via an interlink (e.g., bus) 6008. The machine 6000 may further include a display unit 6010, an alphanumeric input device 6012 (e.g., a keyboard), and a user interface (UI) navigation device 6014 (e.g., a mouse). In an example, the display unit 6010, input device 6012 and UI navigation device 6014 may be a touch screen display. The machine 6000 may additionally include a storage device (e.g., drive unit) 6016, a signal generation device 6018 (e.g., a speaker), a network interface device 6020, and one or more sensors 6021, such as a global positioning system (GPS) sensor, compass, accelerometer, or other sensor. The machine 6000 may include an output controller 6028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 6016 may include a machine readable medium 6022 on which is stored one or more sets of data structures or instructions 6024 (e.g., software) embodying or utilized by any one or more of the techniques or functions described herein. The instructions 6024 may also reside, completely or at least partially, within the main memory 6004, within static memory 6006, or within the hardware processor 6002 during execution thereof by the machine 6000. In an example, one or any combination of the hardware processor 6002, the main memory 6004, the static memory 6006, or the storage device 6016 may constitute machine readable media.

While the machine readable medium 6022 is illustrated as a single medium, the term “machine readable medium” may include a single medium or multiple media (e.g., a centralized or distributed database, and/or associated caches and servers) configured to store the one or more instructions 6024.

The term “machine readable medium” may include any medium that is capable of storing, encoding, or carrying instructions for execution by the machine 6000 and that cause the machine 6000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 6024 may further be transmitted or received over a communications network 6026 using a transmission medium via the network interface device 6020. The Machine 6000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 6020 may include one or more physical jacks (e.g., Ethernet, coaxial, or phone jacks) or one or more antennas to connect to the communications network 6026. In an example, the network interface device 6020 may include a plurality of antennas to wirelessly communicate using at least one of single-input multiple-output (SIMO), multiple-input multiple-output (MIMO), or multiple-input single-output (MISO) techniques. In some examples, the network interface device 6020 may wirelessly communicate using Multiple User MIMO techniques.

### Other Notes and Non-Limiting Examples

Example 1 is a method for providing a job posting service, the method comprising: at a computing device of the job posting service, using a processor: creating a time series model for forecasting a metric of a given job posting, the time series model created from interaction data describing interactions by members of the job posting service towards job postings on the job posting service; receiving a request from a user for a forecast of the metric for a new job posting; determining the forecast of the metric for the new job posting using the time series model and job posting features of the new job posting; and causing the forecast of the metric to be displayed on a computing device of the user.

In Example 2, the subject matter of Example 1 optionally includes wherein creating the time series model comprises generating an auto-regressive integrated moving average (ARIMA) time series model from the interaction data.

In Example 3, the subject matter of any one or more of Examples 1-2 optionally include wherein creating the time series model comprises: generating a plurality of candidate time series models from the interaction data; utilizing test data to score each of the plurality of candidate time series models; and selecting one of the plurality of candidate time series models as the time series model based upon the scores of the plurality of candidate time series models.

In Example 4, the subject matter of any one or more of Examples 1-3 optionally include wherein creating the time series model comprises generating the time series model daily.

In Example 5, the subject matter of any one or more of Examples 1-4 optionally include wherein the method comprises: segmenting the interactions by members of the job posting service into a member segment; creating a time series from the member segment; and wherein creating the time series model comprises generating the time series model based upon the time series.

In Example 6, the subject matter of Example 5 optionally includes wherein creating the time series model comprises generating a correlation ratio that corresponds to a proportion of the interactions by the members attributable to interactions with job postings with the job posting features.

In Example 7, the subject matter of Example 6 optionally includes wherein determining the forecast of the metric for the new job posting using the time series model and the job posting features of the new job posting comprises: generating a base forecast using the time series model; and multiplying the base forecast by the correlation ratio to produce the forecast of the metric for the new job posting.

In Example 8, the subject matter of any one or more of Examples 1-7 optionally include wherein the metric comprises one of: an amount of views, an amount of applications, an amount of unique applicants, or an amount of impressions.

In Example 9, the subject matter of any one or more of Examples 1-8 optionally include wherein the time series model is one of a plurality of time series models, each time series model specific to a geographical region, and wherein determining the forecast of the metric for the new job posting using the time series model and characteristics of the new job posting comprises utilizing the time series model corresponding to the geographical location of the job posting.

Example 10 is a machine-readable medium comprising instructions, that when performed by a machine, cause the machine to perform operations comprising: creating a time series model for forecasting a metric of a given job posting, the time series model created from interaction data describing interactions by members of a job posting service towards job postings on the job posting service; receiving a request from a user for a forecast of the metric for a new job posting; determining the forecast of the metric for the new job posting using the time series model and job posting features of the new job posting; and causing the forecast of the metric to be displayed on a computing device of the user.

In Example 11, the subject matter of Example 10 optionally includes wherein the operations of creating the time series model comprises operations for generating an auto-regressive integrated moving average (ARIMA) time series model from the interaction data.

In Example 12, the subject matter of any one or more of Examples 10-11 optionally include wherein the operations of creating the time series model comprises operations for: generating a plurality of candidate time series models from the interaction data; utilizing test data to score each of the plurality of candidate time series models; and selecting one of the plurality of candidate time series models as the time series model based upon the scores of the plurality of candidate time series models.

In Example 13, the subject matter of any one or more of Examples 10-12 optionally include wherein the operations of creating the time series model comprises operations for generating the time series model daily.

In Example 14, the subject matter of any one or more of Examples 10-13 optionally include wherein the operations further comprise: segmenting the interactions by members of the job posting service into a member segment; creating a time series from the member segment; and wherein creating the time series model comprises generating the time series model based upon the time series.

In Example 15, the subject matter of Example 14 optionally includes wherein the operations for creating the time series model comprises operations for generating a correlation ratio that corresponds to a proportion of the interactions by the members attributable to interactions with job postings with the job posting features.

In Example 16, the subject matter of Example 15 optionally includes wherein the operations for determining the forecast of the metric for the new job posting using the time series model and the job posting features of the new job posting comprises operations for: generating a base forecast using the time series model; and multiplying the base forecast by the correlation ratio to produce the forecast of the metric for the new job posting.

In Example 17, the subject matter of any one or more of Examples 10-16 optionally include wherein the metric comprises one of: an amount of views, an amount of applications, an amount of unique applicants, or an amount of impressions.

In Example 18, the subject matter of any one or more of Examples 10-17 optionally include wherein the time series model is one of a plurality of time series models, each time series model specific to a geographical region, and wherein the operations of determining the forecast of the metric for the new job posting using the time series model and characteristics of the new job posting comprises operations for utilizing the time series model corresponding to the geographical location of the job posting.

Example 19 is a system comprising: a processor; a memory communicatively coupled to the processor and comprising instructions, that when performed by the processor, cause the system to perform operations comprising: creating a time series model for forecasting a metric of a given job posting, the time series model created from interaction data describing interactions by members of a job posting service towards job postings on the job posting service; receiving a request from a user for a forecast of the metric for a new job posting; determining the forecast of the metric for the new job posting using the time series model and job posting features of the new job posting; and causing the forecast of the metric to be displayed on a computing device of the user.

In Example 20, the subject matter of Example 19 optionally includes wherein the operations of creating the time series model comprises operations for generating an auto-regressive integrated moving average (ARIMA) time series model from the interaction data.

In Example 21, the subject matter of any one or more of Examples 19-20 optionally include wherein the operations of creating the time series model comprises operations for: generating a plurality of candidate time series models from the interaction data; utilizing test data to score each of the plurality of candidate time series models; and selecting one of the plurality of candidate time series models as the time series model based upon the scores of the plurality of candidate time series models.

In Example 22, the subject matter of any one or more of Examples 19-21 optionally include wherein the operations of creating the time series model comprises operations for generating the time series model daily.

In Example 23, the subject matter of any one or more of Examples 19-22 optionally include wherein the operations further comprise: segmenting the interactions by members of the job posting service into a member segment; creating a time series from the member segment; and wherein creating the time series model comprises generating the time series model based upon the time series.

In Example 24, the subject matter of Example 23 optionally includes wherein the operations for creating the time series model comprises operations for generating a correlation ratio that corresponds to a proportion of the interactions by the members attributable to interactions with job postings with the job posting features.

In Example 25, the subject matter of Example 24 optionally includes wherein the operations for determining the forecast of the metric for the new job posting using the time series model and the job posting features of the new job posting comprises operations for: generating a base forecast using the time series model; and multiplying the base forecast by the correlation ratio to produce the forecast of the metric for the new job posting.

In Example 26, the subject matter of any one or more of Examples 19-25 optionally include wherein the metric comprises one of: an amount of views, an amount of applications, an amount of unique applicants, or an amount of impressions.

In Example 27, the subject matter of any one or more of Examples 19-26 optionally include wherein the time series model is one of a plurality of time series models, each time series model specific to a geographical region, and wherein the operations of determining the forecast of the metric for the new job posting using the time series model and characteristics of the new job posting comprises operations for utilizing the time series model corresponding to the geographical location of the job posting.

Example 28 is a device comprising: means for creating a time series model for forecasting a metric of a given job posting, the time series model created from interaction data describing interactions by members of a job posting service towards job postings on the job posting service; means for receiving a request from a user for a forecast of the metric for a new job posting; means for determining the forecast of the metric for the new job posting using the time series model and job posting features of the new job posting; and means for causing the forecast of the metric to be displayed on a computing device of the user.

In Example 29, the subject matter of Example 28 optionally includes wherein the operations of creating the time series model comprises operations for generating an auto-regressive integrated moving average (ARIMA) time series model from the interaction data.

In Example 30, the subject matter of any one or more of Examples 28-29 optionally include wherein the operations of creating the time series model comprises operations for: means for generating a plurality of candidate time series models from the interaction data; means for utilizing test data to score each of the plurality of candidate time series models; and means for selecting one of the plurality of candidate time series models as the time series model based upon the scores of the plurality of candidate time series models.

In Example 31, the subject matter of any one or more of Examples 28-30 optionally include wherein the means for creating the time series model comprises means for generating the time series model daily.

In Example 32, the subject matter of any one or more of Examples 28-31 optionally include wherein the device further comprises: means for segmenting the interactions by members of the job posting service into a member segment; means for creating a time series from the member segment; and wherein creating the time series model comprises generating the time series model based upon the time series.

In Example 33, the subject matter of Example 32 optionally includes wherein the means for creating the time series model comprises means for generating a correlation ratio that corresponds to a proportion of the interactions by the members attributable to interactions with job postings with the job posting features.

In Example 34, the subject matter of Example 33 optionally includes wherein the means for determining the forecast of the metric for the new job posting using the time series model and the job posting features of the new job posting comprises: means for generating a base forecast using the time series model; and means for multiplying the base forecast by the correlation ratio to produce the forecast of the metric for the new job posting.

In Example 35, the subject matter of any one or more of Examples 28-34 optionally include wherein the metric comprises one of: an amount of views, an amount of applications, an amount of unique applicants, or an amount of impressions.

In Example 36, the subject matter of any one or more of Examples 28-35 optionally include wherein the time series model is one of a plurality of time series models, each time series model specific to a geographical region, and wherein the means for determining the forecast of the metric for the new job posting using the time series model and characteristics of the new job posting comprises means for utilizing the time series model corresponding to the geographical location of the job posting.

What is claimed is:

1. A method for providing a job posting service, the method comprising:
at a computing device of the job posting service, using a processor:
creating a time series model for forecasting a metric of a given job posting, the time series model created from interaction data describing interactions by members of the job posting service towards job postings on the job posting service;
receiving a request from a user for a forecast of the metric for a new job posting;
determining the forecast of the metric for the new job posting using the time series model and job posting features of the new job posting; and
causing the forecast of the metric to be displayed on a computing device of the user.

2. The method of claim 1, wherein creating the time series model comprises generating an auto-regressive integrated moving average (ARIMA) time series model from the interaction data.

3. The method of claim 1, wherein creating the time series model comprises:
generating a plurality of candidate time series models from the interaction data;
utilizing test data to score each of the plurality of candidate time series models; and
selecting one of the plurality of candidate time series models as the time series model based upon the scores of the plurality of candidate time series models.

4. The method of claim 1, wherein creating the time series model comprises generating the time series model daily.

5. The method of claim 1, wherein the method comprises:
segmenting the interactions by members of the job posting service into a member segment;
creating a time series from the member segment; and wherein creating the time series model comprises generating the time series model based upon the time series.

6. The method of claim 5, wherein creating the time series model comprises generating a correlation ratio that corresponds to a proportion of the interactions by the members attributable to interactions with job postings with the job posting features.

7. The method of claim 6, wherein determining the forecast of the metric for the new job posting using the time series model and the job posting features of the new job posting comprises:
generating a base forecast using the time series model; and
multiplying the base forecast by the correlation ratio to produce the forecast of the metric for the new job posting.

8. The method of claim 1, wherein the metric comprises one of: an amount of views, an amount of applications, an amount of unique applicants, or an amount of impressions.

9. The method of claim 1, wherein the time series model is one of a plurality of time series models, each time series model specific to a geographical region, and wherein determining the forecast of the metric for the new job posting using the time series model and characteristics of the new job posting comprises utilizing the time series model corresponding to the geographical location of the job posting.

10. A machine-readable medium comprising instructions, that when performed by a machine, cause the machine to perform operations comprising:
creating a time series model for forecasting a metric of a given job posting, the time series model created from interaction data describing interactions by members of a job posting service towards job postings on the job posting service;
receiving a request from a user for a forecast of the metric for a new job posting;
determining the forecast of the metric for the new job posting using the time series model and job posting features of the new job posting; and
causing the forecast of the metric to be displayed on a computing device of the user.

11. The machine-readable medium of claim 10, wherein the operations of creating the time series model comprises operations for generating an auto-regressive integrated moving average (ARIMA) time series model from the interaction data.

12. The machine-readable medium of claim 10, wherein the operations of creating the time series model comprises operations for:
generating a plurality of candidate time series models from the interaction data;
utilizing test data to score each of the plurality of candidate time series models; and
selecting one of the plurality of candidate time series models as the time series model based upon the scores of the plurality of candidate time series models.

13. The machine-readable medium of claim 10, wherein the operations of creating the time series model comprises operations for generating the time series model daily.

14. The machine-readable medium of claim 10, wherein the operations further comprise:
segmenting the interactions by members of the job posting service into a member segment;
creating a time series from the member segment; and wherein creating the time series model comprises generating the time series model based upon the time series.

15. The machine-readable medium of claim 14, wherein the operations for creating the time series model comprises operations for generating a correlation ratio that corresponds to a proportion of the interactions by the members attributable to interactions with job postings with the job posting features.

16. The machine-readable medium of claim 15, wherein the operations for determining the forecast of the metric for the new job posting using the time series model and the job posting features of the new job posting comprises operations for:
generating a base forecast using the time series model; and
multiplying the base forecast by the correlation ratio to produce the forecast of the metric for the new job posting.

17. The machine-readable medium of claim 10, wherein the metric comprises one of: an amount of views, an amount of applications, an amount of unique applicants, or an amount of impressions.

18. The machine-readable medium of claim 10, wherein the time series model is one of a plurality of time series models, each time series model specific to a geographical region, and wherein the operations of determining the forecast of the metric for the new job posting using the time series model and characteristics of the new job posting comprises operations for utilizing the time series model corresponding to the geographical location of the job posting.

19. A system comprising:
a processor;
a memory communicatively coupled to the processor and comprising instructions, that when performed by the processor, cause the system to perform operations comprising:
creating a time series model for forecasting a metric of a given job posting, the time series model created from interaction data describing interactions by members of a job posting service towards job postings on the job posting service;
receiving a request from a user for a forecast of the metric for a new job posting;
determining the forecast of the metric for the new job posting using the time series model
and job posting features of the new job posting; and
causing the forecast of the metric to be displayed on a computing device of the user.

20. The system of claim 19, wherein the operations of creating the time series model comprises operations for generating an auto-regressive integrated moving average (ARIMA) time series model from the interaction data.

21. The system of claim 19, wherein the operations of creating the time series model comprises operations for:
generating a plurality of candidate time series models from the interaction data;
utilizing test data to score each of the plurality of candidate time series models; and
selecting one of the plurality of candidate time series models as the time series model based upon the scores of the plurality of candidate time series models.
